(19) United States
(12) Patent Application Publication
(10) Pub. No.: US 2004/0237810 A1
(43) Pub. Date: Dec. 2, 2004

(54) Device and method for producing a bale of bulk goods

(75) Inventor: Marius Cornelis de Baat, Bergschenhoek (NL)

Correspondence Address: Steven M. Koehler, Westman, Champlin & Kelly, Suite 1600, 900 Second Avenue South, Minneapolis, MN, 55402-3319, US

(73) Assignee: Logitec Plus B.V., Capelle A/D Ijssel (NL)

(21) Appl. No.: 10/788,887

(22) Filed: Feb. 27, 2004

(30) Foreign Application Priority Data
Feb. 28, 2003 (NL) 1022808

(51) Int. Cl. B30B 15/30; B30B 15/32; B30B 5/00

(52) U.S. Cl. 100/218; 100/215

(57) ABSTRACT

A device for compressing bulk goods into a bale, in view of packing it bale-shaped on a pallet, includes an upright, tubular shaft having an upper end and a lower end, a supplier adapted for supplying bulk goods to a feed opening in the shaft, a support placed below the lower end and adapted for supporting the bulk goods in the shaft, a press adapted for pressing the bulk goods present in the shaft downwards in order to compress said material into a bale, wherein the support comprises a pressing table, having a mover adapted for moving the pressing table between a position in which the bale is supported below the shaft and a position in which the bale is supported spaced sidewards from the shaft, wherein the device is furthermore provided with a mechanism adapted for keeping a pallet below the shaft, in a position below the pressing table, and with a discharger adapted for discharging the pallet including the bale away from them.

### BACKGROUND OF THE INVENTION

The invention relates to a device and a method for producing optionally packed, compressed bales of bulk goods, such as peat or potting compost.

It is known to compress bulk goods into a bale and to subsequently wrap it in foil, wherein the bulk goods are cast into a tubular fill and compression shaft, onto a bottom formed by a pallet, optionally with a bottom of the foil covering yet to be made or finished placed in between.

The mass of bulk goods in the shaft is subsequently compressed using a pressing stamp that extends from the top into the shaft and is pressed downward. After pressing the bulk goods into a compressed bale, the shaft is removed, for instance by lifting it, and the bale is wrapped with the foil to finish the covering. The assembly of pallet and bale is then discharged, and the process can be repeated again for making a next bale.

A drawback of the known method is that the pallet, which is usually made of wood, has to furnish the counterforce when pressing the bale. The pallets, that often have been used for quite some time already, may not always be able to furnish said forces, resulting in the upper side of the pallet collapsing. When this is noticed in time the compression process will be stopped and the pallet used will be removed. This requires a considerable effort, whereas the process also has to be interrupted.

The consequences may be more serious, however, when the collapsing or rupture of the pallet goes unnoticed. During handling the bale including the pallet at a later stage, such as during transport, the bale may tilt and cause damage, particularly entail a safety hazard.

### SUMMARY OF THE INVENTION

From one aspect the invention to that end provides a device for compressing bulk goods into a bale, in view of packing it bale-shaped on a pallet, comprising an upright, tubular shaft having an upper end and a lower end, means for supplying bulk goods to a feed opening in the shaft, means placed below the lower end for supporting the bulk goods in the shaft, means for pressing the bulk goods present in the shaft downwards in order to compress said material into a bale, wherein the support means comprise a pressing table, having means for moving the pressing table between a position in which the bale is supported below the shaft and a position in which the bale is supported spaced sidewards from the shaft, wherein the device is furthermore provided with means for keeping a pallet below the shaft, in a position below the pressing table, and with means for discharging the pallet including the bale away from them.

By placing a pressing table in between during the pressing, the pallet is kept free from the pressure forces, yet it is already positioned for receiving and supporting the bale after pressing. Pressure forces may now be utilised independent of the strength and condition of the pallet. An increased compression, which previously was unachievable with the usual pallets, may now even be opted for. A great advantage furthermore is that there is a very large freedom in the choice of pallet type. Particularly lightweight and cheap pallets, which previously would have been too weak, such as disposable pallets in particular, can be used.

The means for moving the pressing table may also form means for supplying the pallet to a position below the shaft and below the pressing table. Thus the device can be kept simple in that respect.

In one embodiment the pressing table comprises a pressing plate and below the pressing plate a receiving space for the pallet, so that the vertical distance between pallet and pressing surface can remain small for that matter while keeping the pallet free.

The supply means may comprise a support situated below the path of movement of the pressing table for supporting the pallet while it is being supplied. The pallet can then simply be received from a pallet supply and also be discharged.

In one embodiment the means for discharging the pallet comprise a conveyor for movably supporting the pallet in the position below the shaft and for discharging it therefrom. Thus not only the discharge is facilitated, but also the pressing table may under conditions be moved freely with respect to the pallet, particularly when moving back the pressing table.

In a further development the means for moving the pressing table comprise at least one piston/cylinder assembly, of which one end is fixed and the other end is attached to the pressing table. Preferably the supply conveyor is placed between two piston/cylinder assemblies, as a result of which not only a stable motion of the pressing plate is achieved, but also room is provided for supply of a pallet to the pressing plate.

In one embodiment the pressing table is provided with means, such as catches or hooks, that can be brought in and out of engagement with the pallet for taking it along in the move of the pressing table. The pallet simply lying between the cylinders under the pressing table, can be taken along, along with the motion of the pressing table.

In a further development the device is provided with means for packing the bale, wherein the means for packing the bale are adapted for wrapping the bale, wherein the device is furthermore provided with means for lifting the shaft during wrapping the bale. Thus a compact, quickly operating device is provided.

From another aspect the invention provides a method for compressing bulk goods into a bale and the packing of said bale on a pallet, wherein the bulk goods are introduced into a shaft provided with a circumferential wall and an open lower end, wherein below the shaft lower end a pressing plate is positioned, and a pallet is positioned underneath the pressing plate, wherein within the shaft a pressing stamp is pressed downwards to press the bulk goods downwards against the pressing plate in order to in cooperation with the circumferential wall of the shaft compress the bulk goods into a bale, wherein after pressing the pressing table is removed but the pallet is left and the bale is enveloped with a covering.

The packing can take place elsewhere, but preferably the covering is arranged in situ after removal of the pressing table.

In one embodiment, prior to filling the shaft, a bottom of a covering to be made for the bale is held on the pressing plate at the lower end of the shaft, and the rest of the covering is arranged and sealed around the bale positioned on the pallet after removal of the pressing plate.

In one embodiment, after pressing the pressing stamp is retained, in contact with the bale, the pressing plate is removed but the pallet is left, the bale is allowed to expand downwards until in supportive contact with the bottom of the covering and/or the pallet, after which optionally a covering is arranged.

In a quick embodiment of the method, the covering is arranged during lifting the shaft, by unrolling covering material around the bale from the lower end.

The pressing stamp may be kept substantially at the same level during lifting the shaft.

In a further development thereof, after enveloping the bale, a part of the covering that extends beyond the upper end of the bale and below the lower end of the lifted shaft is laced up, is sealed at two spaced apart locations and is severed between those two sealing locations.

The pressing plate may be supplied together with a pallet to below the lower end of the shaft.

In one embodiment, when removing the pressing plate it is transported back to the pallet discharge, where a next pallet is placed below the pressing plate and subsequently the pressing plate with pallet is moved again to below the lower end of the shaft.

### BRIEF DESCRIPTION OF THE DRAWINGS

The invention will be elucidated on the basis of an exemplary embodiment shown in the attached drawings, in which:

FIG. 1 shows a schematic view of an exemplary embodiment of a compression and packing device according to the invention, at the start of compression/packing cycle;

FIG. 2 shows the device of FIG. 1 in a first operative stage;

FIG. 3 shows the device of FIG. 1 in a second operative stage;

FIG. 4 shows the device of FIG. 1 in a third operative stage;

FIG. 5 shows the device of FIG. 1 in a fourth operative stage;

FIG. 6 shows the device of FIG. 1 in a fifth operative stage;

FIG. 7 shows the device of FIG. 1 in a sixth operative stage;

FIG. 8 shows the device of FIG. 1, when finishing the compression/packing cycle;

FIG. 9 shows the device of FIG. 1, when discharging the bale/pallet made; and

FIG. 10 shows a schematic cross-section of a part of the device of FIG. 1.

### DETAILED DESCRIPTION OF THE PREFERRED EMBODIMENTS

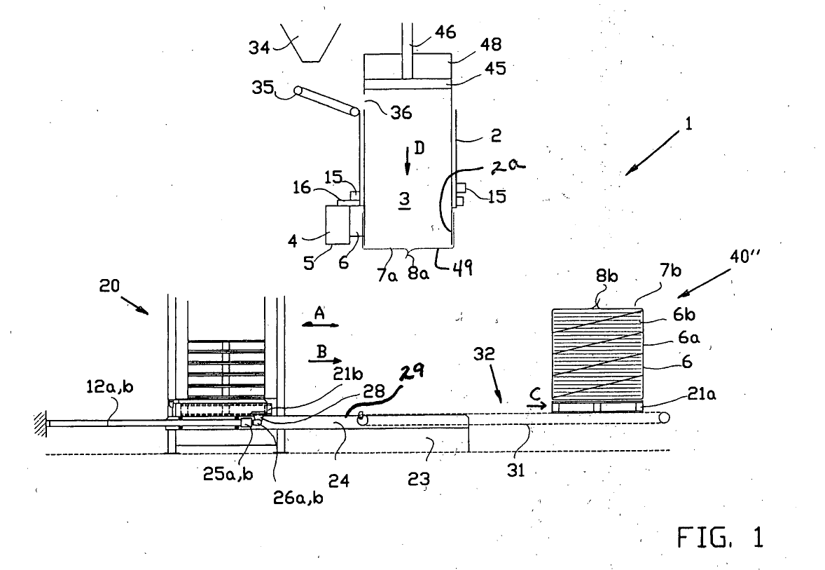

The device 1 of FIG. 1 ff. is supported on a permanent basis that is not shown. Device 1 comprises a compression shaft 2 that is positioned vertically and, as is usual, has a rectangular circumferential wall defining a fill space 3 for bulk goods, and an upper end 48 and an open lower end 49. In the upper area the shaft 2 is furthermore provided with a feed opening 36, onto which a supply conveyor 35 that receives bulk goods from a buffer 34 debouches.

From the upper end 48 of the shaft 2 a pressing stamp 45 extends, that is suspended from a pressing rod 46, that can be activated in downward direction, and can be lifted again in opposite direction, using means such as actuators that are known per se and are not shown here.

The lower portion 49 of the shaft 2 is formed by a circumferential thinner plate 2a. Just above it a circulating path 15 is attached to the shaft 2, over which path rollers 16 of a wrapping device 4 that is provided with a driving motor are able to move in a circumferential path around the shaft 2. Wrapping device 4 comprises a roll 5 with a web of wrapping foil 6.

In FIG. 1, some foil (from roll 5) is wrapped around the lower portion 2a, wherein also a bottom 7a is formed which is sealed at the location of seal 8a. The lower end 49 is thus sealed off by the foil.

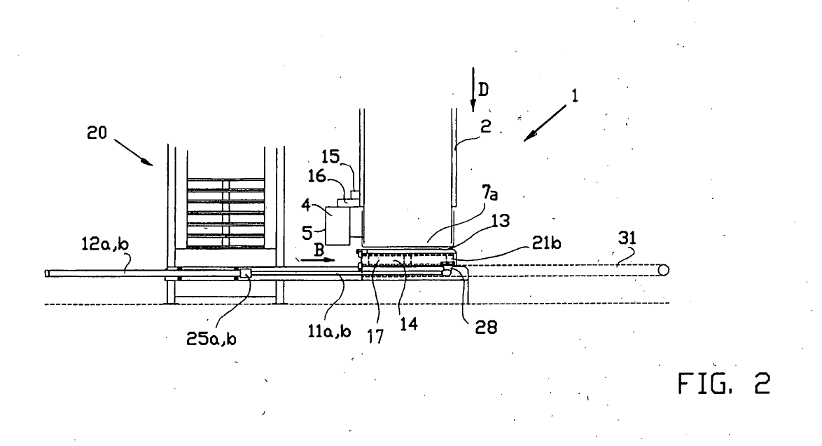

Vertically below the shaft 2 a movable pressing table 10 can be situated (FIG. 2), which comprises a pressing blade or plate 13 and support legs 14. Said support legs 14 have been arranged on either side, namely parallel to the shown direction of movement B. Below the pressing plate 13 a receiving space 17 is formed for a pallet 21b.

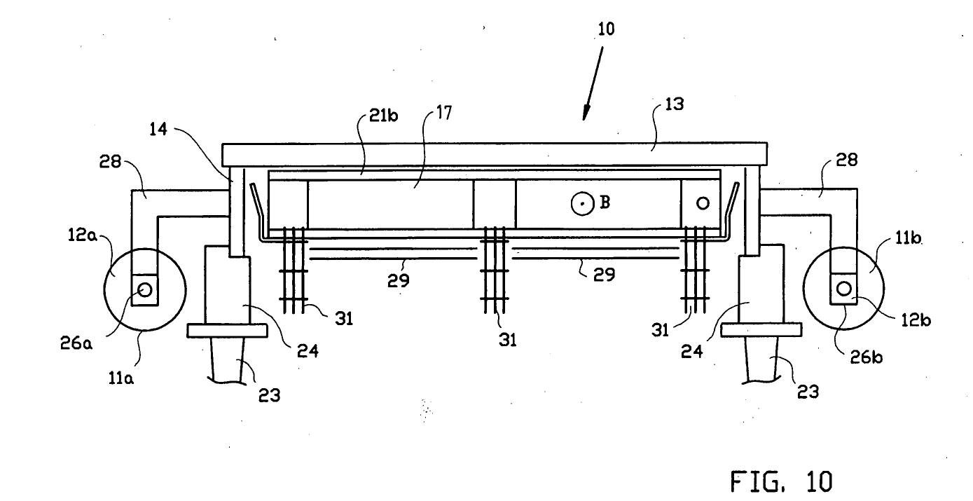

The pressing table 10, as can be seen in FIG. 10, is supported by the legs 14 on fixed guides 24, which are attached to the upper side of the longitudinal girders 23, which themselves are supported on a permanent basis.

The legs 14 are attached via rigidly attached metal, L-shaped parts 28 to ends 26a,b of piston rods 11a, 11b, that are expandable and retractable in the direction A, from fixedly positioned hydraulic cylinders 12a, 12b having heads 25a,b to provide a mover for the pressing table 10. As will be understood from FIG. 10, the cylinders 12a,b are placed on either side of the path of movement of the pressing table 10. In this way room is provided for longitudinal overlap with the chains 31 of discharge conveyor 32.

During the supply, the pallets 21 are supported on a support plate 29, for sliding transport thereon of the pallets 21, as considered in the drawing to the right. The support plate 29 is also schematically shown in FIG. 10, and then supports a pallet 21. It can be seen that the upper side of the pallet 21 is free from the lower side of the lower side of the pressing plate 13.

The pressing table 10 is furthermore provided with catches 27 that have been arranged, as considered in the drawing on the left-hand side of the pressing plate 13 and that are biased from a position, in which the receiving space 17 is freely accessible (from the left) to a pallet 21, to an extended position in which the catches 27 engage behind the pallet 21 and take it along to the right when the pressing table 10 is moved.

The guides 24 and the support plate 29 end under the area below the shaft 2 where the chain conveyor 32 with circulating chain 31 is also present. The chain conveyor 32 can be driven to discharge a pallet 21a, 21b including bale 40′ to the right.

The operation of the device 1 is as follows.

In FIG. 1 the shaft 2 is placed in the highest position, because a bale 40″ made earlier together with pallet 21a has just been discharged in the direction C, using the chain conveyor 32. At the location of the support plate 29 a pallet 21b from the stock 20 is placed, on the support plate 29 between the guides 24. After that by operating the hydraulic cylinders 12a, 12b the pressing table 10 is transported back to the left, to the position indicated by the dashed lines. In that process, the catches 27 at the pressing table have resiliently collapsed and after that of their own accord extend behind the pallet 21. The pallet 21b is then received in the space 17 within the pressing table 10. Subsequently the hydraulic cylinders 12a, 12b are operated for transport of the pressing table 10 in the direction B, over the guides 24, to exactly below the shaft. The catches 27 here take along the pallet 21b, the pallet 21b then sliding over the support plate 29, and in vertical direction being free from the pressing plate 13. By means of legs 14, the pressing table 10 remains supporting on the end portions of the guides 24 therefore shown in FIG. 10.

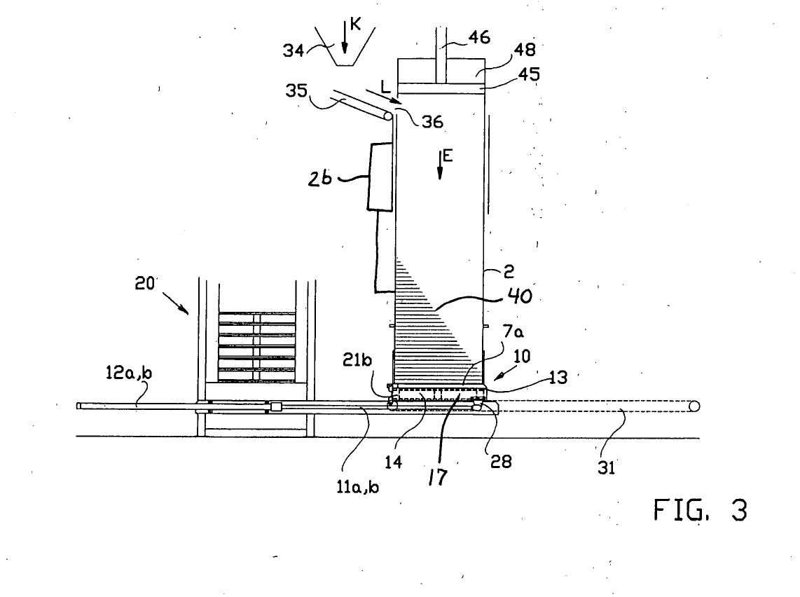

Subsequently the shaft 2, as shown in FIG. 2, is moved downwards by a mover such as an actuator schematically indicated at 2b in FIG. 3 in the direction D, until the foil bottom 7a rests on the pressing plate 13, and the opening 49 almost connects to the pressing plate 13.

Then, as indicated in FIG. 3, bulk goods, particularly peat or potting compost, is supplied in the direction K, into stock 34, is discharged from there via supplying belt 35 in the direction L in the opening 36, in order to then fall down in the direction E in the internal space 3 of the shaft 2.

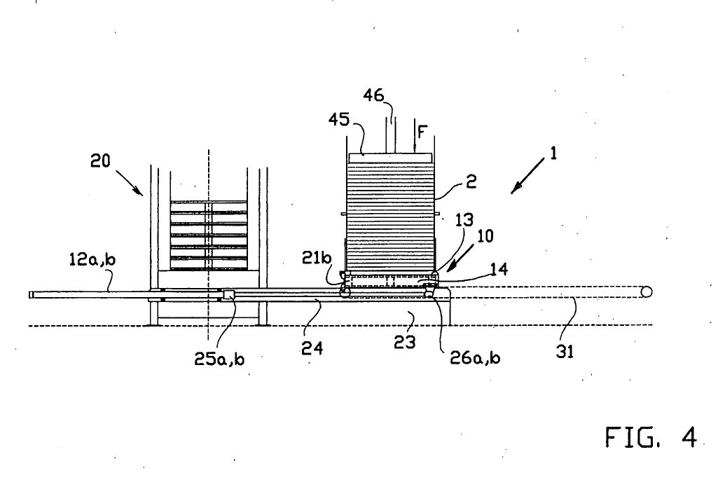

Subsequently the pressing stamp 45 is operated (FIG. 4) to move downwards in the direction F, and press on the bulk goods 40 with the pressing surface 47, during which subsequently high pressure forces are exerted in the direction F, in order to compress the bulk goods 40 into a block 40′. The intended vertical counterforce is furnished by the pressing table 10 (which is held stationary), particularly the pressing plate 13, wherein the pallet 21 is safeguarded against the high pressure forces.

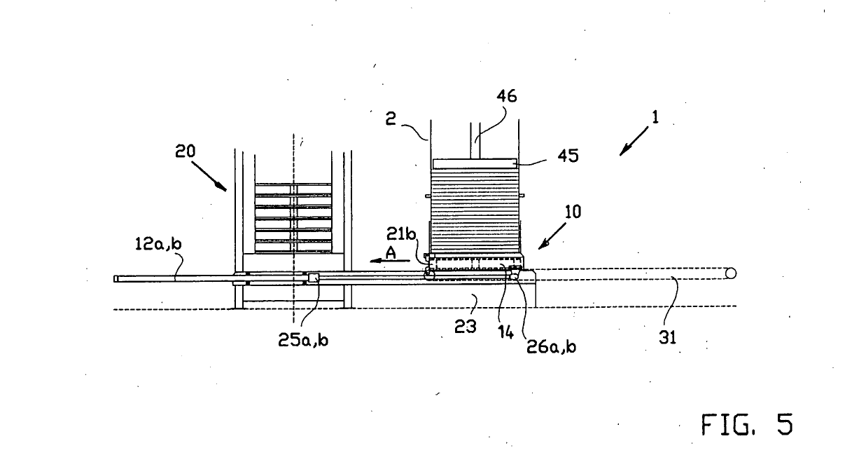

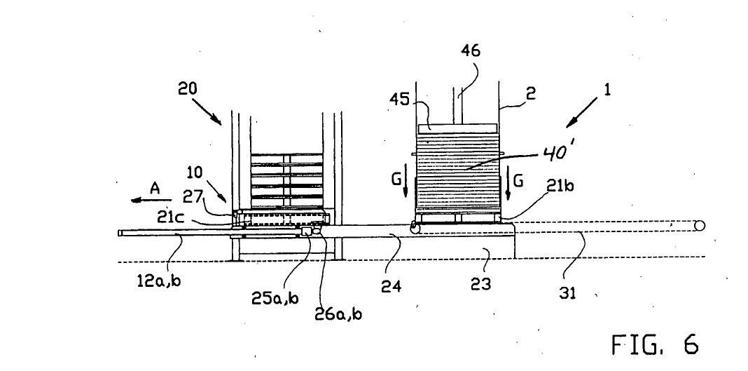

Then the situation shown in FIG. 5, in which the compression is finished, is achieved. The shaft 2 and the pressing stamp 46 are then kept at an unaltered, constant level, and the cylinders 12a, 12b are operated to retract the pressing table 10 in the direction A, see FIG. 6. Underneath the pressing table 10 a next pallet 21c is received again in the receiving space 15, in the manner described above.

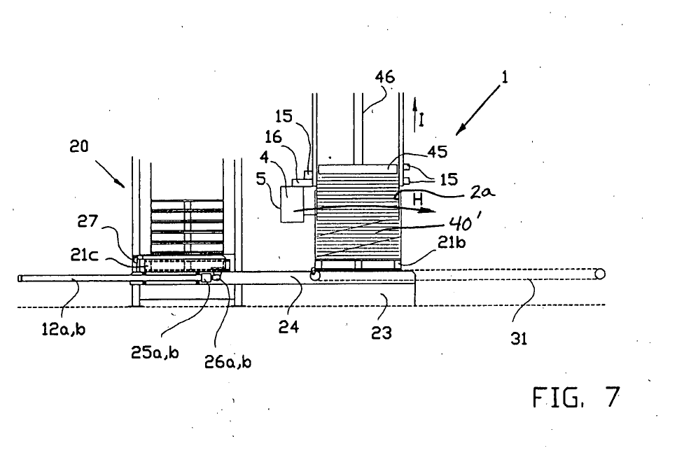

Because the pressing table 10 is no longer present below the shaft 2, the bulk goods, while taking along the foil bottom 7a, are able to expand/sag in direction G down to the upper surface of the pallet 21b, under the influence of gravity and as a result of relaxation forces within the compressed bulk goods in bale shape 40′. Then (FIG. 6) the wrapping device 4 is operated, and a web of foil 6 is unrolled from the roll 5, while the wrapping device 4 circulates over the path 15 in the direction H. Here the foil web 6 is also wrapped around an upper portion of the pallet 21b. Subsequently, under continuous activation of the wrapping device 4, the shaft 2 is lifted in the direction I (FIG. 7), resulting in the webs 6a, 6b being wrapped around the bale 40′ and thus a covering is formed. The pressing stamp 46 may still be held at a constant level here, in order to prevent that compressed bulk material is pulled along upwards, and to ensure that the bale 40′ remains intact. The foil 6 wrapped around the lowermost portion 2a can easily slide away from it until in close contact with the side surface of the bale 40′.

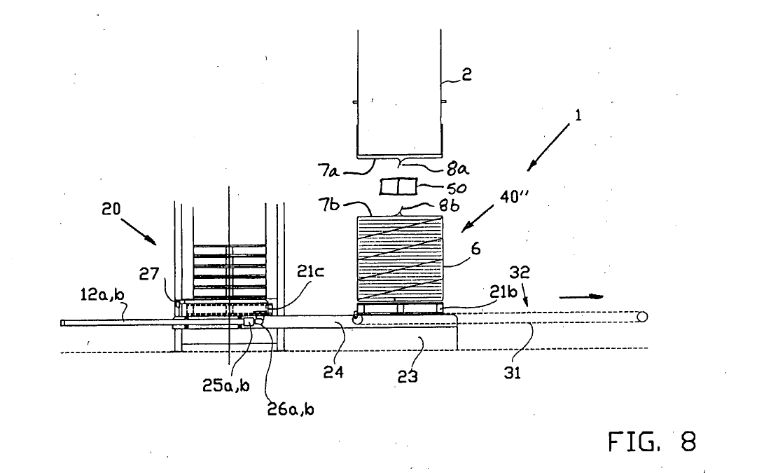

When the lower end 49 of the shaft 2 arrives at the level of the pressing plate 45 the pressing stamp 46 is taken along upwards, and finally the shaft 2 will arrive above the bale 40′. Between the upper side of the bale 40′ and the lower opening 49, a sewing machine known per se and schematically shown at 50 in FIG. 8 will make one long or at least two lacings, where the foil is sealed. At that location the covering is severed, so that the covering of the bale 40″ is also closed at the top by upper wall 7b, sealed at the location of seal 8b. Simultaneously a new bottom 7a having seal 8a has also been realised for the covering of the next bale to be made, see FIG. 8.

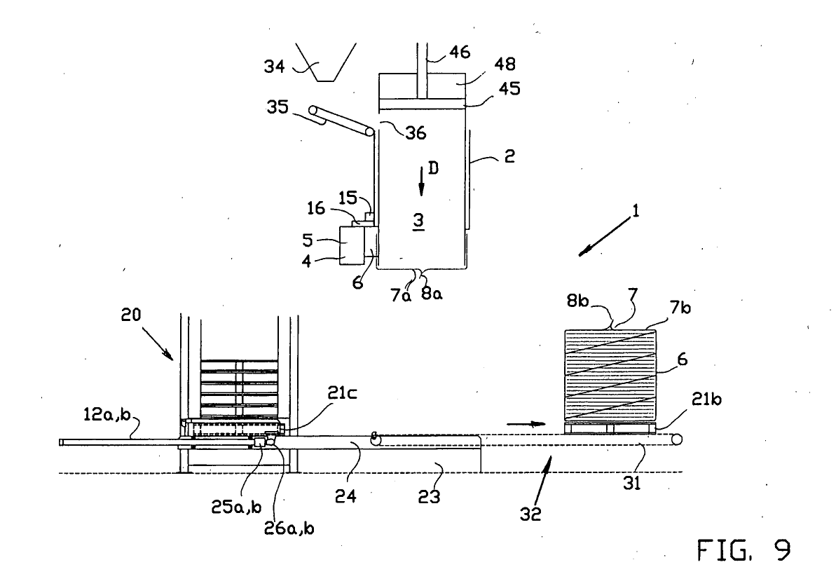

The bale 40″ is then discharged by means of the chain conveyor 32 (FIG. 9).

Although the present invention has been described with reference to preferred embodiments, workers skilled in the art will recognize that changes may be made in form and detail without departing from the spirit and scope of the invention.

What is claimed is:

1. A device for compressing bulk goods into a bale, in view of packing it bale-shaped on a pallet, comprising an upright, tubular shaft having an upper end and a lower end, a supplier adapted for supplying bulk goods to a feed opening in the shaft, a support placed below the lower end and adapted for supporting the bulk goods in the shaft, a press adapted for pressing the bulk goods present in the shaft downwards in order to compress said material into a bale, wherein the support comprises a pressing table, having a mover adapted for moving the pressing table between a position in which the bale is supported below the shaft and a position in which the bale is supported spaced sidewards from the shaft, wherein the device is furthermore provided with a mechanism adapted for keeping a pallet below the shaft, in a position below the pressing table, and with a discharger adapted for discharging the pallet including the bale away from them.

2. The device according to claim 1, wherein the mover is furthermore adapted for supplying the pallet to a position below the shaft and below the pressing table.

3. The device according to claim 2, wherein the pressing table comprises a pressing plate and below the pressing plate a receiving space for the pallet.

4. The device according to claim 3, wherein the support is situated below the path of movement of the pressing table for supporting the pallet while it is being supplied.

5. The device according to claim 2, wherein the discharger comprises a conveyor for movably supporting the pallet in the position below the shaft and for discharging it.

6. The Device according to claim 1, wherein the mover comprises at least one piston/cylinder assembly, of which one end is fixed and the other end is attached to the pressing table.

7. The device according to claim 6, wherein the mover comprises two piston/cylinder assemblies, which are placed on either side of the path of movement of the pallets.

8. The device according to claim 2, wherein the pressing table is provided with a catch that can be brought in and out of engagement with the pallet for taking it along in the move of the pressing table.

9. The device according to claim 1, furthermore provided with means for packing the bale, wherein the means for packing the bale are adapted for wrapping the bale, wherein the device is furthermore provided with means for lifting the shaft during wrapping the bale.

10. A method for compressing bulk goods into a bale and the packing of said bale on a pallet, wherein the bulk goods are introduced into a shaft provided with a circumferential wall and an open lower end, wherein below the shaft lower end a pressing plate is positioned, and a pallet is positioned underneath the pressing plate, wherein within the shaft a pressing stamp is pressed downwards to press the bulk goods downwards against the pressing plate in order to in cooperation with the circumferential wall of the shaft compress the bulk goods into a bale, wherein after pressing the pressing table is removed but the pallet is left and the bale is enveloped with a covering.

11. The method according to claim 10, wherein the covering is arranged in situ after removal of the pressing table.

12. The method according to claim 10, wherein prior to filling the shaft at the lower end of the shaft a bottom of a covering to be made for the bale is held on the pressing plate, and the rest of the covering is arranged and sealed around the bale positioned on the pallet after removal of the pressing plate.

13. The method according to claim 10, wherein after pressing the pressing stamp is retained, in contact with the bale, the pressing plate is removed but the pallet is left, the bale is allowed to expand downwards until in supportive contact with the bottom of the covering and/or the pallet, after which optionally a covering is arranged.

14. The method according to claim 12, wherein the covering is arranged during lifting the shaft, by unrolling covering material around the bale from the lower end.

15. The method according to claim 14, wherein the pressing stamp is kept substantially at the same level during lifting the shaft.

16. The method according to claim 14, wherein after enveloping the bale a part of the covering that extends beyond the upper end of the bale and below the lower end of the lifted shaft is laced up, is sealed at two spaced apart locations and is severed between those two sealing locations.

17. The method according to claim 10, wherein the pressing plate is supplied together with a pallet to below the lower end of the shaft.

18. The method according to claim 17, wherein when removing the pressing plate it is transported back to the pallet discharge, where a next pallet is received below the pressing plate and subsequently the pressing plate including pallet is moved again to below the lower end of the shaft.

19. The method according to claim 10, wherein the covering is made by wrapping the bale with a web of foil material from a roll.
